(19) United States
(12) Patent Application Publication
(10) Pub. No.: US 2002/0093766 A1
(43) Pub. Date: Jul. 18, 2002

(54) "SHRINK WRAP" CONFORMAL COATING OF A CHIP-ON-SUSPENSION IN A HARD DISK DRIVE SYSTEM

(76) Inventor: KURT P. WACHTLER, RICHARDSON, TX (US)

Correspondence Address: TEXAS INSTRUMENTS INCORPORATED, P O BOX 655474, M/S 3999, DALLAS, TX, 75265

(21) Appl. No.: 09/464,634

(22) Filed: Dec. 15, 1999

(51) Int. Cl. G11B 5/48

(52) U.S. Cl. 360/244.1

(57) ABSTRACT

A structure and method of coating a chip where thickness can be accurately controlled. In a disclosed embodiment, a chip on suspension is flip-chip mounted in a hard disk drive and conformal coated with a uniform thickness with a material chosen from materials that have a proven acceptance for use in the disk drive environment. The invention includes a “shrink wrap” technique to apply the conformal coating on the flip-chip device.

### FIELD OF THE INVENTION

This invention generally relates to hard disk drives such as those used for computer systems. More particularly, it relates to conformal coating of a chip-on-suspension (COS) to prevent contamination of the disk drive using a “shrink wrap” technique.

### BACKGROUND OF THE INVENTION

In a hard disk drive there is typically a head actuator assembly that positions one or more heads over each spinning disk of a disk platter. The heads write data to the disks by changing the magnetic field of a small area of the disk. In most modern disk drives, the direction of the magnetization of the magnetic material of the disk medium is then detected by a magnetoresistive (MR) or giant magnetoresistive (GMR) head to detect the stored data from the disk. The signal from the MR or GMR head has a very small amplitude. This small signal must be detected by the pre-amplifier over copper wires from the heads. A limitation to increased data rates from the head is the inductance of the wires between the heads and the pre-amplifier, so it is desirable to place the pre-amplifier as close to the head as possible to shorten the wires and lessen the corresponding inductance. Recently, there is an effort to put the pre-amplifier directly on the suspension arm of the head actuator. This is sometimes called chip-on-suspension (COS).

One of the hurdles to overcome for COS is maintaining environmental integrity of the disk system. In typical processes to attach the chip to the suspension particles are created that will damage the disks and head if not sealed or removed. Unwanted particles include pieces of silicon on the back and edges of the chip that are scraped loose during sawing and placement of the chip onto the suspension, and media particles included in the underfill material, which is a compound to physically and thermally seal the chip to the suspension.

One way to control unwanted particles when placing a chip on suspension is to conformal coat the chip. Since the suspension arms are placed together on an actuator block and move in between closely spaced disks, the spacing of the COS is critical. Therefore, the thickness of any coating placed on the device must be precisely controlled to prevent interference with the movement of the suspension arms. Also, the thermal transfer characteristics of the chip require precise control of the coating applied to the chip. Further constraints for the coating include using materials that have a proven record for use in a disk drive environment such that they don't contribute additional particles, outgas or have ionic contaminants.

### SUMMARY OF THE INVENTION

The present invention introduces a structure and method of coating a chip where the thickness of the coating can be accurately controlled, and the coating can be chosen from materials that have a proven acceptance for use in the disk drive environment.

An embodiment of the present invention includes a method of conformal coating a flip-chip mounted device with a layer of material having a uniform thickness where the material is placed over the chip on a heat shrinkable carrier film and set with hot air.

### BRIEF DESCRIPTION OF THE DRAWINGS

The novel features believed characteristic of the invention are set forth in the appended claims. The invention itself, however, as well as other features and advantages thereof, will be best understood by reference to the detailed description which follows, read in conjunction with the accompanying drawings, wherein:

FIG. 1 Shows a prior art hard disk drive and actuator design;

FIG. 2 Shows hard disk drive COS according to an embodiment of the present invention;

FIG. 3 Represents a side view of heat shrinkable film carrier with a layer of adhesive conformal coat material;

FIG. 4 Shows conformal coated COS according to an embodiment of the present invention; and

FIGS. 5a-d Show a sequence for a method of forming the conformal coating according to an embodiment of the present invention.

### DETAILED DESCRIPTION OF THE PREFERRED EMBODIMENTS

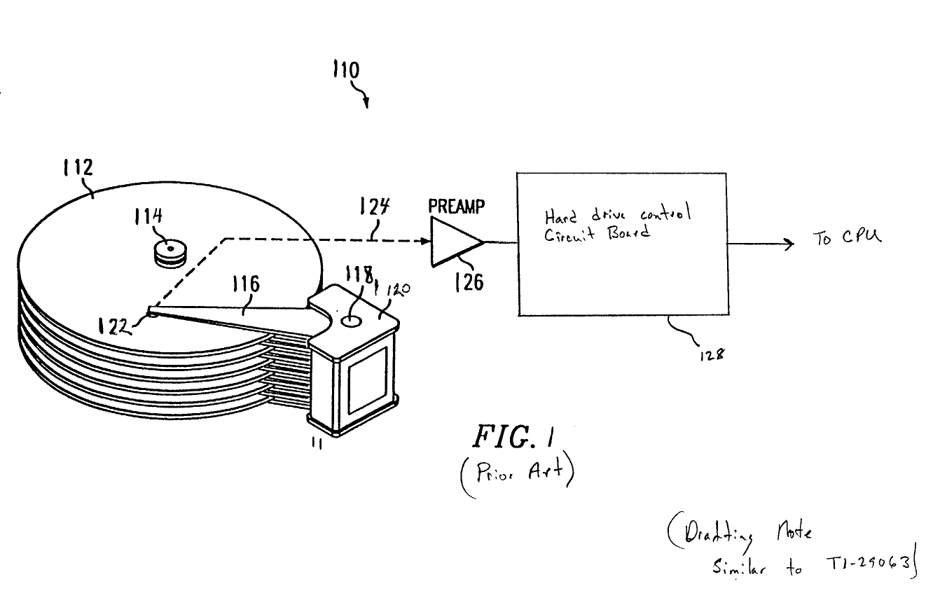

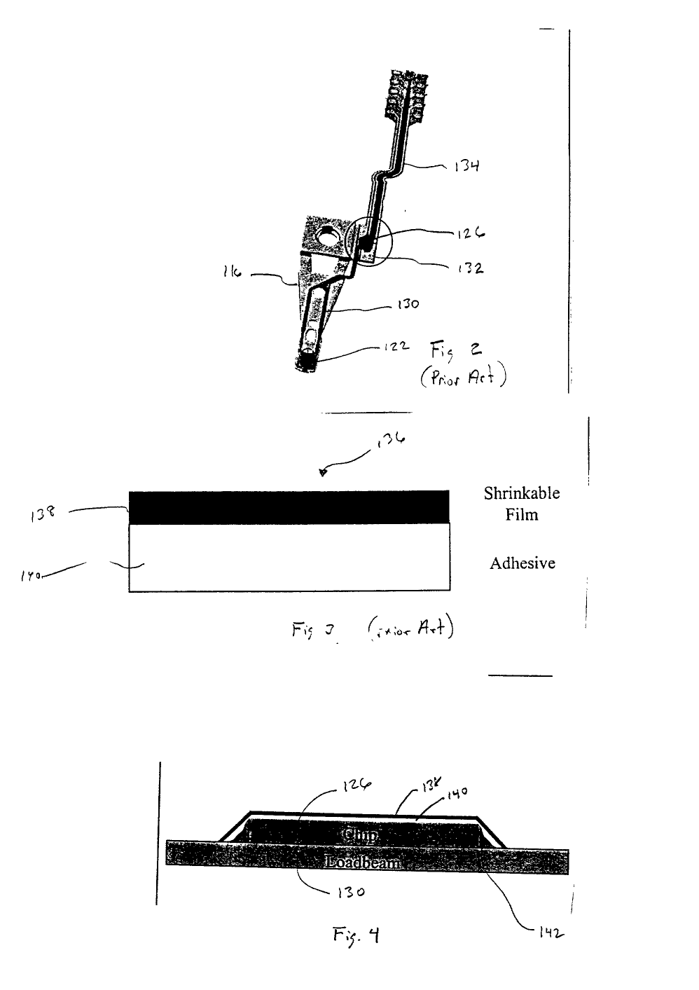

The preferred embodiment of the present invention is best understood by referring to FIGS. 1-5d of the drawings, like numerals are used for like and corresponding parts of the various drawings.

With reference to FIG. 1, there is shown a diagrammatic view of a hard disk drive system 110 that embodies the present invention. The system 110 includes a plurality of magnetic disks 112, which are fixedly secured to a spindle 114 that is rotationally driven by a not-illustrated spindle motor. A plurality of arms 116 are supported for pivotal movement about an axis defined by a pivot axle 118, pivotal movement of the arms 116 being effected under control of a voice coil motor 120. At the outer end of each arm is a read/write head 122. The head 122 includes respective portions that serve as a read head and a write head. As shown diagrammatically at 124, the output of the read head is coupled to an input of a preamplifier 126. The output of the preamplifier 126 is coupled to an input of a hard disk drive control board 128. The control board includes a read channel circuit. The Control board is coupled to the CPU of the computer system (not shown). While this drawing is highly simplified, it illustrates the general concept of hard disk drives according to the prior art.

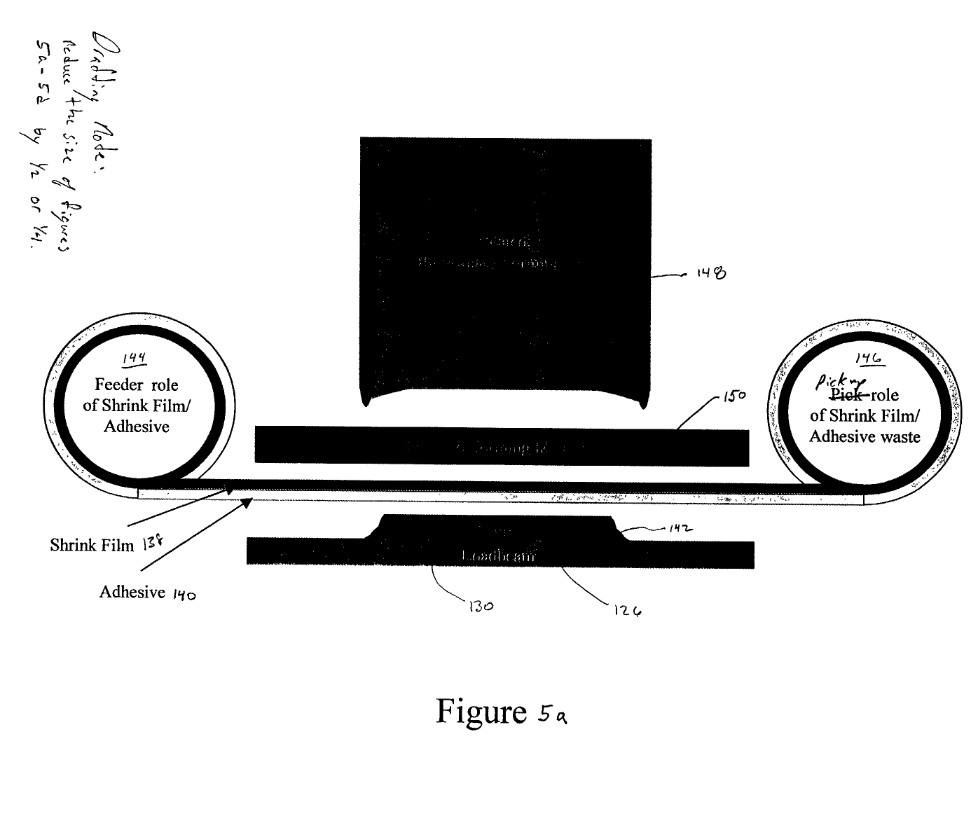

With reference to FIG. 2, there is shown a plane view of a COS according to an embodiment of the present invention. An actuator is shown with a suspension arm 116 having heads 122. Wires 130 connect the head to a pre-amp chip 126 which is flip-chip mounted to the actuator arm 116. The pre-amp chip is located on a shoulder area 132 of the actuator arm to position it closer to the heads. A wire assembly 134 connects the pre-amp to the hard drive control circuit board located in the hard disk assembly.

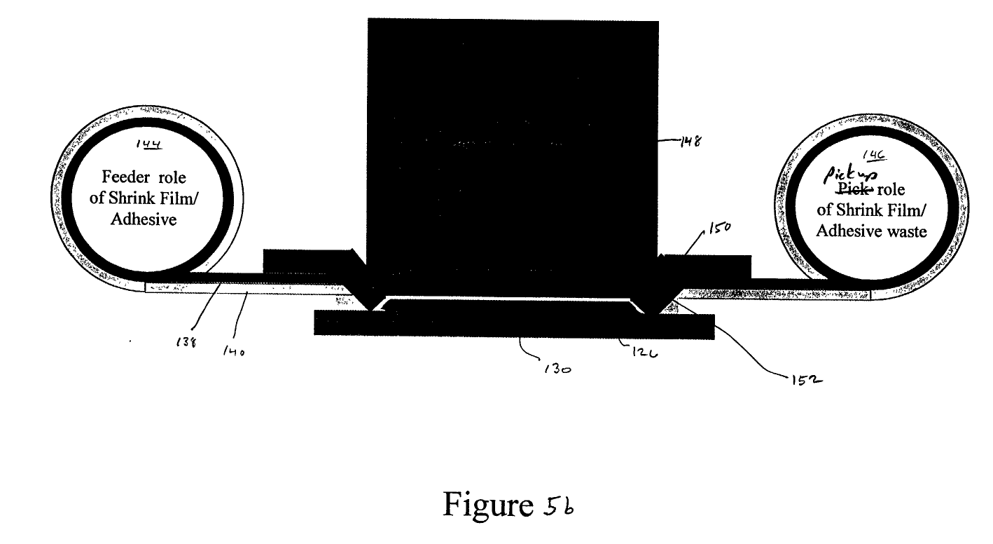

FIG. 3, illustrates a side view of heat shrinkable film 136 that may be applied to the flip-chip to conformal coat the chip and isolate any loose particles on or around the chip. The heat shrinkable film conformal coat includes a layer of heat shrinkable wrap material 138 with an adhesive layer 140. The shrinkable film 138 may be made of polyethelene plastic material. The adhesive 140 is preferably a material that has a proven acceptance for use in hard disk drives such as 3M Corporation's DP-460 epoxy adhesive.

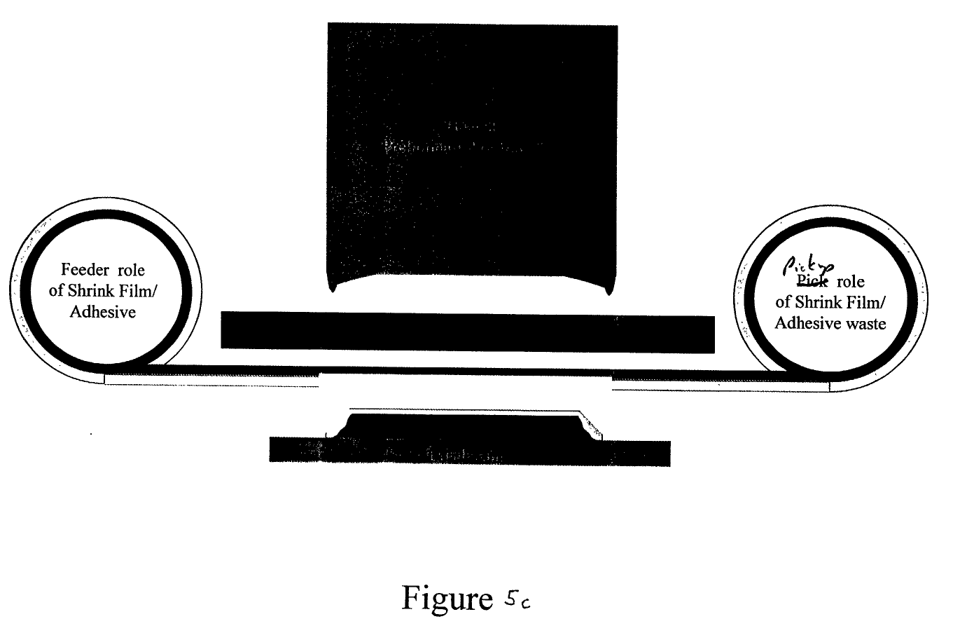

An embodiment of the present invention is described in FIG. 4, which shows a cutaway side view of a flip chip device and a HDD loadbeam 130. The device is the chip on suspension (COS) pre-amp 126 described above. The chip may be mounted using standard flip chip mounting techniques that typically use some form of bump bonds to connected the chip to electrical traces on a substrate or other surface. In this case, the pre-amp device 126 is bump bonded to electrical connections on the surface of the actuator arm. After flip chip mounting, the pre-amp chip is underfilled with a media filled epoxy material 142 which remains at the edges of the chip as shown. The media filled epoxy material contributes unwanted particles that will damage the disks and head if not sealed or removed. Other unwanted particles include pieces of silicon on the back and edges of the chip that are scraped loose during sawing and placement of the chip onto the suspension.

The present invention is concerned with sealing this assembly with an adhesive using a shrinkable/conforming material 138,140. The adhesive 140 may be applied to the shrinkable film 136 with industry standard techniques for coating adhesives onto a roll of plastic film. In a preferred embodiment, the shrinkable film is removed after the adhesive is set and the adhesive becomes a conformal coat over the chip. Alternatively, the shrinkable film may remain on the chip and form part of the conformal coating as shown in FIG. 4.

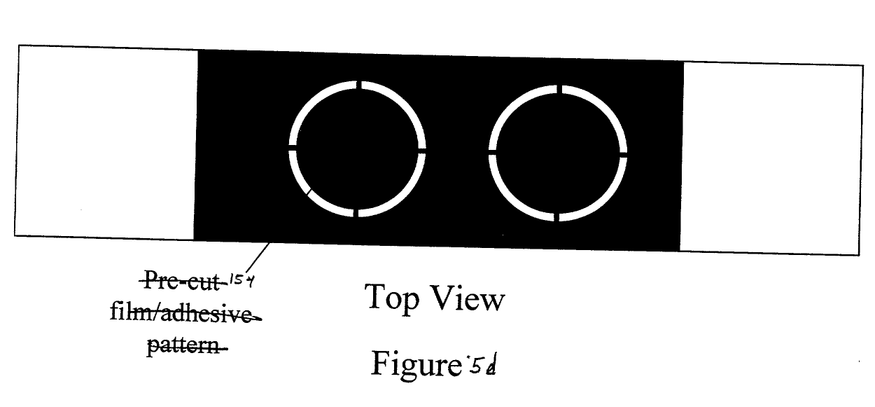

Another embodiment of the present invention is described in FIGS. 5a-d, which show a sequence of cutaway side views of a flip chip device 126 and a HDD loadbeam 130 to illustrate a method of applying the conformal coating. Prior to this process, the flip chip device has been assembled onto the loadbeam and underfilled with a media filled epoxy material 142. The shrink film and adhesive are preferably dispensed from a roll of material with a feeder roll 144 and a pick-up roll 146. The assembly is positioned under the unrolled portion of the shrink film/adhesive material 138,140, which is separated from a heated forming tool 148 by a conforming material 150.

FIG. 5b shows the forming tool 148 gently pressing the conforming material and the shrink film/adhesive into soft contact with the assembly. This contact is maintained sufficiently long to cause the shrink film to perform its natural shrinking process due to the exposure to heat. This shrinking completes the forming of the adhesive to the contours of the flip chip die and underfil material on top of the loadbeam, thus sealing in the undesired particles. Note: The heated forming tool has slight lip 152 around the periphery of the tool. This lip provides a pressure on the edges of the Shrink Film to anchor the edges during the shrinking of the film which in turn provides the conforming pressure rather than just a useless shrink in the horizontal plane of the film.

FIG. 5c depicts the forming tool lifting form the assembly, the shrink film releases from the adhesive and the adhesive remains as a conformal coat on the assembly. After processing the chip as shown above, the shrink film/adhesive is indexed from left to right in preparation for coating the next assembly.

FIG. 5d provides additional detail to a preferred way for preparing the shrink film/adhesive material for the conformal coating process. The shape of the adhesive desired to be transferred to the flip chip and loadbeam assembly is pre-cut into the shrink film/adhesive material 154. This allows control of the amount of material and also facilitates the control of the manner in which the film is held in place while it shrinks. Pre-cutting of the Shrink Film avoids problems with the roll of material when individual pieces are processed during the conformal coating process.

An advantage of the present invention is the thickness of the material on the top surface of the flip-chip mounted device can be accurately controlled and common materials that are used in disk drives can be applied with the preferred method.

An additional advantage of the present invention is that the heat shrinkable film can be placed and set while only applying minimal pressure to the very fragile suspension arm.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A uniformly conformal coated flip-chip mounted electronic device comprising:
a. a semiconductor device flip-chip mounted to a substrate; and
b. a conformal coating of uniform thickness across the entire surface, edges of the chip, and the surface of the substrate immediately around the chip.

2. The structure of claim 1 wherein the substrate is a non-semiconductor substrate.

3. The structure of claim 2 wherein the device is assembled onto the substrate and underfilled with a media impregnated compound.

4. The structure of claim 1 wherein the conformal coating comprises a shrinkable film with an adhesive coating.

5. A hard disk drive assembly comprising:
a. at least one head associated with a disk surface for storing computer data magnetically on the disk;
b. a pre-amp device mounted to a suspension arm of an actuator and connected to the head to receive a signal from the head representing the data stored on the disk; and
c. a conformal coating of uniform thickness across the entire surface, and edges of the chip, and any exposed media impregnated underfill compound around the chip.

6. The structure of claim 1 wherein the substrate is a non-semiconductor substrate.

7. The structure of claim 2 wherein the device is assembled onto the substrate and underfilled with a media impregnated compound.

8. The structure of claim 1 wherein the conformal coating comprises a shrinkable film with an adhesive coating.

9. A method of uniformly conformal coating a flip-chip mounted electronic device, comprising the steps of:
d. flip-chip mounting a semiconductor device to a substrate; and
e. conformal coating a material of uniform thickness across the entire top chip surface.

10. The method of claim 4 wherein the substrate is a non-semiconductor substrate.

11. The method of claim 4 wherein the device is device is assembled onto the substrate and underfilled with a media impregnated.

12. A hard disk drive for a computer system comprising:
a. one or more platters having magnetic media on one or more surfaces;
b. an actuator having at least one suspension arm for positioning a read/write head over said platter;
c. flip-chip mounting a semiconductor device to said suspension arm on said actuator; and
d. conformal coating a material of uniform thickness across the entire top chip surface edges of the chip, and any exposed media impregnated underfill compound around the chip.

13. The hard disk drive of claim 7 wherein said conformal coat includes a heat shrinkable film with an adhesive layer.

14. The structure of claim 1 wherein the conformal coating comprises a shrinkable film with an adhesive coating.
